(19) United States
(12) Patent Application Publication
(10) Pub. No.: US 2012/0144215 A1
(43) Pub. Date: Jun. 7, 2012

(54) MAXIMUM CURRENT LIMITING METHOD AND APPARATUS

(75) Inventors: Samuel D. Naffziger, Fort Collins, CO (US); John P. Petry, San Diego, CA (US); Kiran Bondalapati, Los Altos, CA (US)

(73) Assignee: ADVANCED MICRO DEVICES, INC., Sunnyvale, CA (US)

(21) Appl. No.: 12/960,095

(22) Filed: Dec. 3, 2010

(51) Int. Cl. G06F 1/32; G06F 1/26

(52) U.S. Cl. 713/320; 713/340

(57) ABSTRACT

The maximum current is limited in a multi-processor core system by monitoring the latest power consumption in the processor cores, in order to prevent a system shutdown as a result of an over-current event. If the sum of the latest power of the processor cores exceeds a threshold limit, a performance state (P-state) limit is enforced in the processor cores. The P-state limit causes a P-state change to a lower frequency, voltage and thus a lower current.

### FIELD OF INVENTION

This application is related to multi-processor core systems and, in particular, limiting maximum current in multi-processor core systems.

### BACKGROUND

FIG. 1 is an example functional block diagram of a multi-processor core system 100. The multi-processor core system 100 includes processor 105, which includes n processor cores 102₁ . . . 102ₙ, chipset 120, which includes a Northbridge 110 and a Southbridge 115, and external voltage regulator (VR) 114. The Northbridge 110 is connected to the processor 105 via a processor bus 118, and to the Southbridge via a peripheral bus 122. Not all components of the multi-processor core system 100 are shown.

The processor 105 may be any type of processor such as a central processing unit (CPU) or a graphics processing unit (GPU). For example, processor 105 may be an x86 processor that implements x86 64-bit instruction set architecture and is used in desktops, laptops, servers, and superscalar computers; an Advanced Reduced Instruction Set Computer (RISC) Machine (ARM) processor that is used in mobile phones or digital media players; or a digital signal processor (DSP) that is useful in the processing and implementation of algorithms related to digital signals, such as voice data and communication signals, and microcontrollers that are useful in consumer applications, such as printers and copy machines. Although only one processor 105 is shown in FIG. 1, the system 100 may include multiple processors.

The processor 105 may include one or more processor cores 102₁ . . . 102ₙ, which form the computational centers of the processor 105 and are responsible for performing a multitude of computational tasks. For example, processor cores 102₁ . . . 102ₙ may include, but are not limited to, execution units that perform additions, subtractions, shifting and rotating of binary digits, and address generation and load and store units that perform address calculations for memory addresses and the loading and storing of data from memory. The operations performed by processor cores 102₁ . . . 102ₙ enable the running of computer applications.

The Northbridge 110 and the Southbridge 115 contain logic that facilitates the processor 105 to communicate with other hardware components. For example, the Northbridge 110 facilitates processor 105 communication with the VR 114, and the Southbridge 115 facilitates processor 105 communication with peripherals through a peripheral component interconnect (PCI) slot (not shown). The Northbridge 110 may also be referred to as the memory controller hub (MCH) and the Southbridge 115 may also be referred to as the input/output (I/O) controller hub (ICH).

When applications are run on the processor cores 102₁ . . . 102ₙ, the application activity may affect how much current is used in the processor cores. Multi-processor core systems are susceptible to high current usage if a number of the processor cores operate at high frequency as a result of high application activity. An over-current event that cannot be supported by the VR 114 will cause the undesirable scenario of the VR 114 and the entire system shutting down.

In order to safeguard against over-current conditions, the maximum power consumption for the chip may be determined in advance for all the given components on a voltage rail by running a synthetic trace that generates a worst case power. The worst case power may then be used as a guard band in order to not exceed the electrical limits of the VR 114, where the VR 114 is used to identify spikes in the current.

Problems with relying on the VR 114 to regulate current are that the sampling rates of the VR 114 may be too slow to detect a spike in current, and the VR 114 may not be able to provide the telemetry information to the processor cores 102₁ . . . 102ₙ fast enough to avoid the over-current event. Additionally, the accuracy of analog current sensors that would be used in the VR 114 tends to be low, with typically a 15% error margin.

### SUMMARY OF EMBODIMENTS

A system and method for regulating the maximum current in a multi-core processor system is disclosed. The latest power of the processor cores is monitored. If the processor core powers exceed a threshold limit, then a performance state (P-state) limit is enforced on the processor cores, causing the processor cores to lower their power, voltage and frequency, and thus lowering the current. In an alternate embodiment, the P-state limit may be enforced when the processor core power is observed to exceed a threshold limit for a predetermined period of time. In another embodiment, the increasing or decreasing trend in processor core power may be used to make the decision whether or not to enforce the P-state limit.

### BRIEF DESCRIPTION OF THE DRAWINGS

A more detailed understanding may be had from the following description, given by way of example in conjunction with the accompanying drawings wherein:

FIG. 1 is an example functional block diagram of a multi-processor core system;

FIG. 2 shows an example of a maximum current limiting method;

FIG. 3 is an example functional block diagram of a multi-processor core system including a maximum current limiting system; and

FIG. 4 shows examples of supply current values.

### DETAILED DESCRIPTION

The teachings described herein are described with respect to multi-processor core systems, but may similarly be used in systems-on-a-chip (SOCs) with a single processor core. The maximum current limiting system and method, as described herein, may provide a quicker response time than over-current detection via the external VR, and may also achieve a higher degree of accuracy because the digital power monitors in the processor cores are more accurate than an analog ammeter. The maximum current limiting system and method, as described herein, may be used in combination with a guard band in the VR, to provide two layers of protection from over-current events.

The teachings herein involve adjusting the performance state (P-state) of one or more of the processor cores when an over-current event is detected. P-states are described as follows. The Advanced Configuration and Power Interface (ACPI) standard is an operating system-based specification that regulates a computer system's power management. For example, the ACPI standard may control and direct the processor cores for better management of battery life. In doing so, ACPI assigns processor power states, referred to as C-states, and forces a processor to operate within the limits of these states. There are varying levels of C-states that a processor may be assigned as shown in Table 1, along with the corresponding implication for a processor's performance.

TABLE 1
An example of processor C-states

| C-state, i.e. | |
|---|---|
| power state | Implication |
| C0 | Fully working state, full power consumption, full |
| | dissipation of energy. |
| C1 | Sleeping state, stop the execution of instructions, may |
| | return to execution of instructions instantaneously |
| C2 | Sleeping state, may take longer to go back to C0 state |

While a processor is in the fully working C0 state, it will be associated with another state, referred to as the performance state or the P-state. There are varying levels of P-states that are each associated with an operating voltage and frequency. The highest performance state is P0, which may correspond to maximum operating power, voltage and frequency. However, a processor may be placed in lower performance states, for example P1 or P2, which correspond to lower operating power, voltage and/or frequency. Generally, when a processor moves to a lower P-state it will operate at a lower capacity than before. Table 2 shows an example of the P-states that a processor in C0 state may attain, along with the corresponding implications.

TABLE 2
An example of processor P-states for the C0 state

| P-state— | |
|---|---|
| performance state | Implication |
| P0 | Maximum operating power, voltage and frequency |
| P1 | Less operating power, voltage and frequency than P0 |
| | state |
| P2 | Less operating power, voltage and frequency than P1 |
| | state |

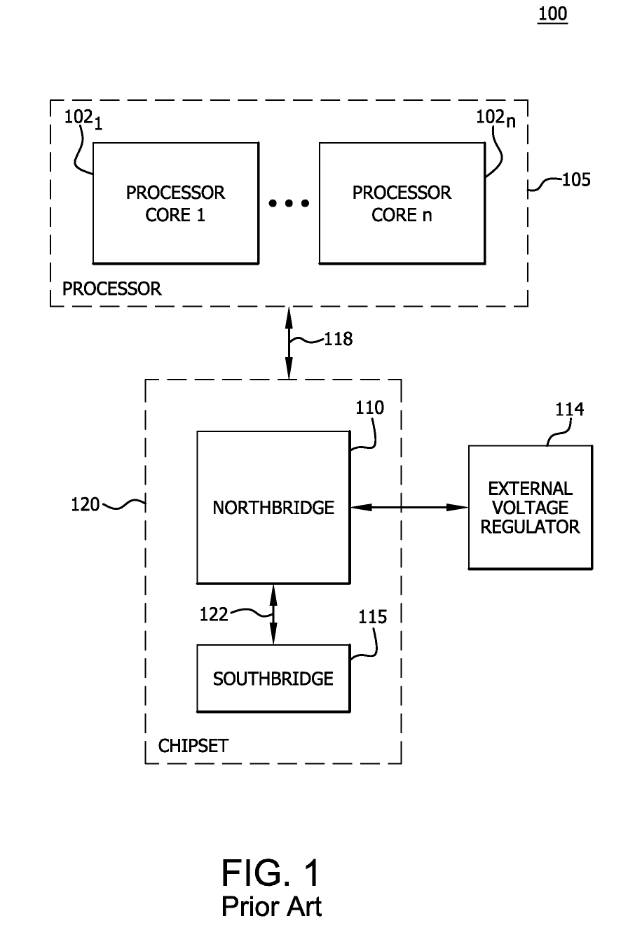

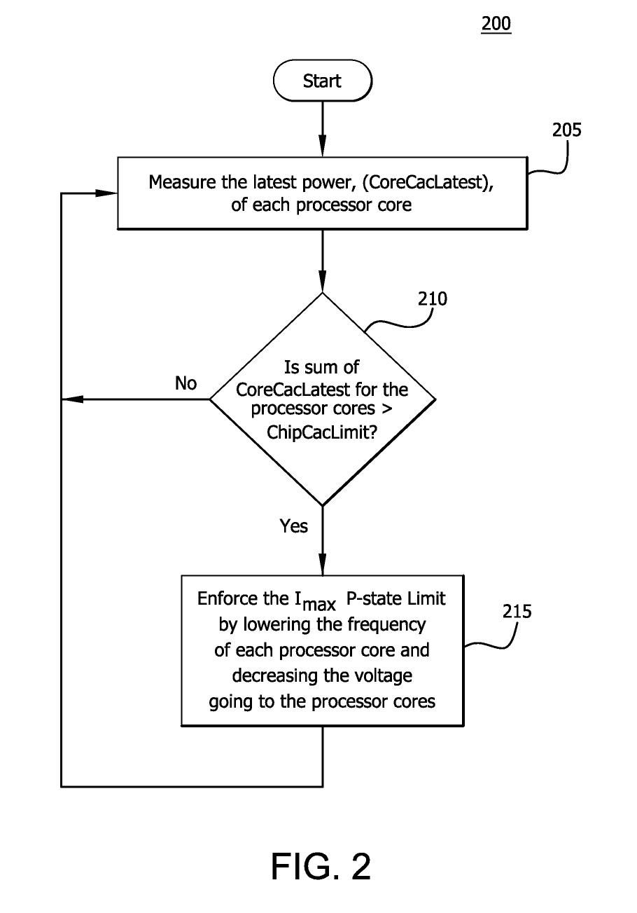

FIG. 2 shows an example of a maximum current limiting method, in accordance with the teachings herein. In step 205, the power of each of the processor cores is measured (the processor cores may be processor cores 102₁ . . . 102ₙ in FIG. 1, for example). Preferably, the latest power, (CoreCacLatest), for each processor core is measured. The latest power, (CoreCacLatest), is the most recent sample of instantaneous power of the corresponding processor core, and therefore may be considered an energy value. In an alternate embodiment, the average power, (CoreTdpAvg), may be measured instead of or in addition to the latest power, (CoreCacLatest). The average power, (CoreTdpAvg), is the average of instantaneous power samples over a window of time.

Preferably, a digital power monitor is included in each processor core to measure and report each core's power value(s). The power monitors may be located within the circuitry that generates a current spike in order to provide a better response time in detecting the current spike. The power monitors may use fixed-time sampling to measure and report latest power (and/or average power). An example power monitor is further described in U.S. patent application Ser. No. 12/101,598, which is incorporated herewith by reference.

In step 210, the sum of the latest power, (CoreCacLatest), of the processor cores is compared to a threshold limit, ChipCacLimit. In an alternate embodiment, the average power over an interval of time, (CoreTdpAvg), may be used to compare the short term average power of the processor cores to a threshold limit. In another embodiment, the latest power samples, (CoreCacLatest), of the processor cores may be observed over an interval of time for an increasing or decreasing trend in the processor cores' power. For example, an increase (or decrease) in power value of the latest power samples of the processor cores over a duration of time may be compared to a predetermined threshold value.

The power information of the processor cores may be reported by the power monitors to logic in the Northbridge that tracks the power in the processor cores. The Northbridge receives power values of each of the processor cores from the power monitors at regular intervals. Preferably, the Northbridge samples the latest power, (CoreCacLatest), such that the sampling bandwidth exceeds that of the VR, in order to provide a sufficiently fast response time to prevent an over-current shut down.

In step 210, the latest powers, (CoreCacLatest), of the processor cores are summed together and compared to the threshold limit ChipCacLimit. If the sum of the latest powers, (CoreCacLatest), of the processor cores is less than the threshold limit ChipCacLimit, then the process returns to step 205 to continue monitoring for over-current events. If the sum of the latest powers, (CoreCacLatest), of the processor cores is greater than the threshold limit ChipCacLimit, then an over-current event has been detected and the maximum current P-state limit, Iₘₐₓ, is enforced on each processor core, in step 215.

According to an alternate embodiment, the P-state limit, Iₘₐₓ, may be enforced if the short term average power, (CoreTdpAvg), of the processor cores exceeds a threshold value. In this case, the average powers, (CoreTdpAvg), of the processor cores may be summed together and compared the threshold value. According to yet another embodiment, the P-state limit, Iₘₐₓ, may be enforced if the increase (or decrease) in the latest power of the processor cores, relative to the prior reading of the power of the processor cores, exceeds a threshold value. In this case, the latest power of the processor cores may be summed together and compared to the sum of the prior power readings of the processor cores.

In step 215, the Iₘₐₓ P-state limit is enforced by reducing the frequency of each processor core and decreasing the voltage going to the processor cores. In general, the processor cores control their own frequency, but are on a common V_{DD} (Voltage drain drain) voltage plane such that the voltage of the processor cores is controlled by a common (external) VR. Alternatively, if the processor cores are not on a common voltage plane, the voltages of the processor cores may be controlled separately.

In general, the Iₘₐₓ P-state is the base state for the multi-processor core system. For example, referring to Table 2, the Iₘₐₓ P-state may be P-state P2. Provided that the Iₘₐₓ P-state limit is applied before the VR responds to the current spike, the frequency of all the processor cores is reduced and the potential over-current scenario is mitigated. The Iₘₐₓ P-state limit may be programmable and may cause the P-state (i.e. frequency, voltage and power) of all processor cores to be changed to a programmable value, in order to support devices with different power capabilities.

Additionally, not shown in FIG. 2, an interrupt may be signaled to notify higher layer software that the Iₘₐₓ P-state limit was enforced in the processor cores. The higher layer software may log the event or take corrective action with regards to utilization of the processor cores.

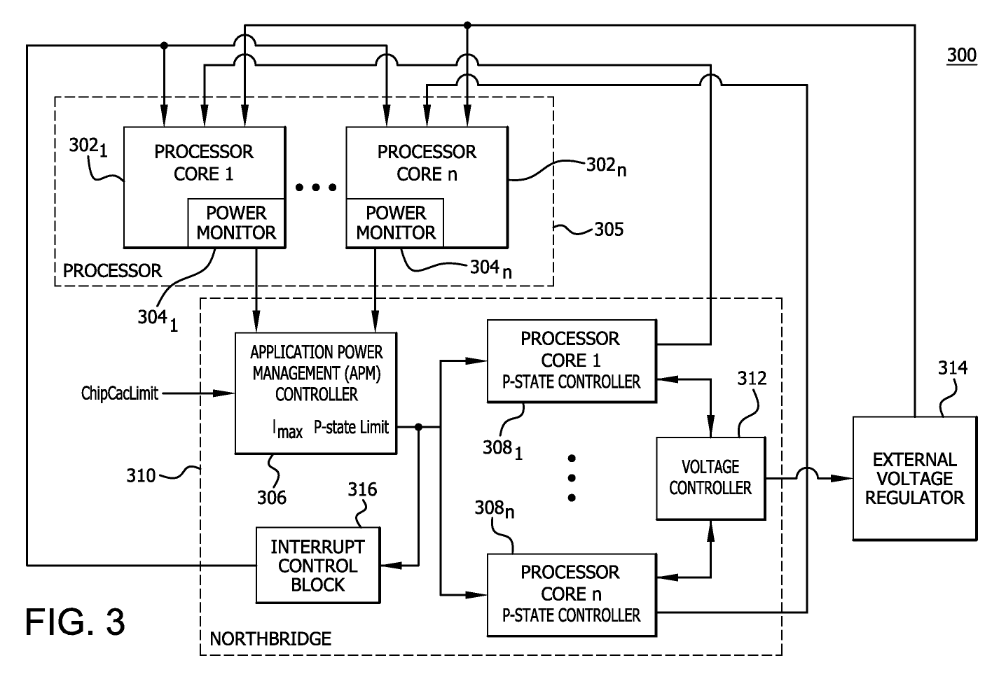

FIG. 3 shows a multi-processor core system 300 employing a maximum current limiting method. The multi-processor core system 300 includes a processor 305 including n processor cores 302₁ . . . 302ₙ (where n is two or more), each with a corresponding power monitor 304₁ . . . 304ₙ, and a Northbridge 310 including an application power management (APM) controller 306, n processor core P-state controllers 308₁ . . . 308ₙ, a voltage controller 312, and an interrupt controller (316). The APM controller 306 is configured with the programmable threshold limit ChipCacLimit, and the programmable P-state limit, Iₘₐₓ. ChipCacLimit may be an instantaneous power value, or energy value, and Iₘₐₓ may be a current value. The external VR 314 is external to the multi-processor core system 300. Not all components of the multi-processor core system 300 are shown, for example, the Southbridge has been omitted for simplicity, but it should be understood that the omitted components may be included. The maximum current limiting system in FIG. 3 is described using the latest power, (CoreCacLatest), of the processor cores, 302₁ . . . 302ₙ, however, other power values may be used in a similar manner. For example the average power, (CoreTdpAvg), or the increase or decrease in power of the processor cores, 302₁ . . . 302ₙ, over an interval of time may be used in place of the latest power.

Each power monitor 304₁ . . . 304ₙ measures a latest power or energy value, (CoreCacLatest), for the respective processor cores 302₁ . . . 302ₙ, and reports the latest power values, (CoreCacLatest), to the APM controller 306. The APM controller 306 samples the power values from the processor cores 302₁ . . . 302ₙ at regular intervals. For each set of power samples, the APM controller 306 sums the power values, (CoreCacLatest), over the processor cores and compares the sum of the power values to the threshold limit ChipCacLimit. If the sum exceeds ChipCacLimit, the APM controller 306 sends a notification to the processor-core P-state controller 308₁ . . . 308ₙ that the threshold value ChipCacLimit has been exceeded. The APM controller 306 may also notify the interrupt control block 316 that the ChipCacLimit has been exceeded.

In response to the signal form the APM controller 306, the processor core P-state controllers 308₁ . . . 308ₙ send signals to the respective processor cores 302₁ . . . 302ₙ to lower their P-states, and therefore lower their frequency. The processor core P-state controllers 308₁ . . . 308ₙ also notify the voltage controller 312. The voltage controller 312 is responsible for sending a signal to the external VR 314 to notify the VR 314 to lower the V_{DD} voltage, (i.e. the positive supply voltage), that goes to all the processor cores 302₁ . . . 302ₙ. The voltage controller 312 may in turn notify the processor core P-state controllers 308₁ . . . 308ₙ when the voltage transition of the processor cores 302₁ . . . 302ₙ is complete. This notification may occur before the P-state frequency change has occurred. This is relevant to the case where the processor cores 302₁ . . . 302ₙ move to a higher P-state and the voltage should be increased before the frequency can be increased. This is generally not an issue when the processor cores 302₁ . . . 302ₙ move to a lower P-state.

In response to the signal from the APM controller 306, the interrupt controller 316 sends an interrupt signal to the processor cores 302₁ . . . 302ₙ in order to notify higher layer software that the Iₘₐₓ P-state limit was enforced. Higher layer software may take some action based on this information, for example, it may limit a particular P-state utilization after a certain number of logged Iₘₐₓ P-state limit events.

The APM controller 306, the core P-state controllers 308₁ . . . 308ₙ, the voltage controller 312, and the interrupt controller 316 represent functional partitions of logic that typically reside in the Northbridge 310, and may be used in a multi-processor core system individually, or in any combination. For example, the n core P-state controllers 308₁ . . . 308ₙ may be combined as one P-state controller that controls the frequency of all of the processor cores 302₁ . . . 302ₙ. In another example, the interrupt controller 316 may be omitted. These components may also be located in a logic block other than in the Northbridge.

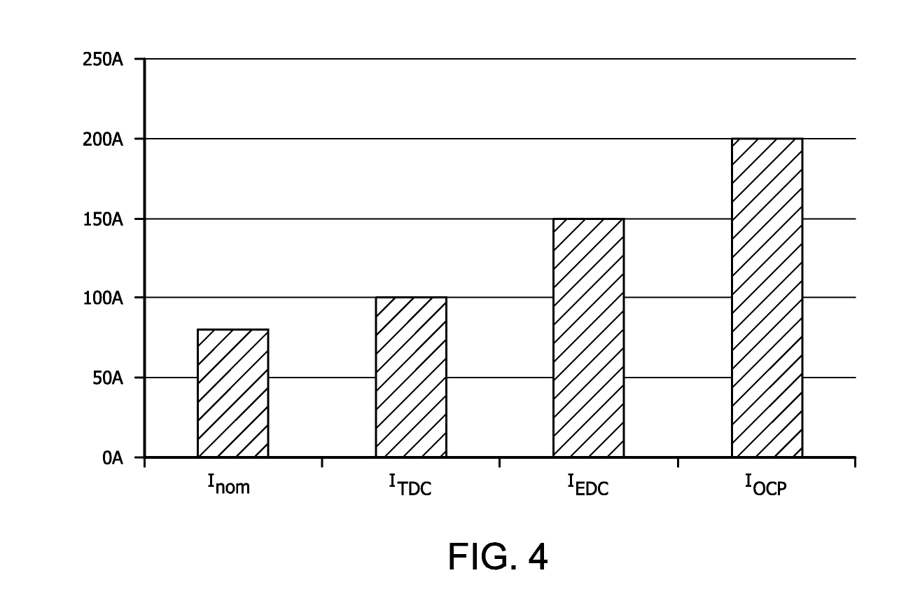

FIG. 4 shows examples of supply current values, in amperes (A), for a VR. Iₙₒₘ is the nominal or typical current value for the VR (for example, external VR 314 in FIG. 3 and external VR 114 in FIG. 1). ITDC is the thermal design current, which is the maximum current sustainable over thermally significant time frames (for example, tens of milliseconds). I_{EDC} is the maximum electrical design current sustainable over short, non-thermally significant, time periods (for example, less than 10 milliseconds). I_{EDC} is the value that may be used to set the Iₘₐₓ P-state limit, which is the current value that is enforced on the processor cores (for example, CP cores 302₁ . . . 302ₙ in FIG. 3) when a maximum current event is detected. I_{OCP} is the current level at which the VR will shut down.

Although features and elements are described above in particular combinations, each feature or element can be used alone without the other features and elements or in various combinations with or without other features and elements. The apparatus described herein may be manufactured by using a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture semiconductor devices (e.g., processors) that embody various aspects of the present invention. Suitable processors include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

What is claimed is:

1. A method for limiting the maximum current in a multi-processor core system comprising:
measuring a latest power for each processor core in a plurality of processor cores;
comparing the sum of the latest power of the processor cores to a threshold limit; and
enforcing a performance state (P-state) limit on each processor core responsive to the sum exceeding the threshold limit, wherein the processor cores enter a lower performance state.

2. The method of claim 1 wherein the measuring the latest power for each processor core is done using fixed-time sampling.

3. The method of claim 2 wherein a sampling bandwidth of the fixed-time sampling exceeds the sampling bandwidth of a voltage regulator (VR).

4. The method of claim 1 wherein the measuring the latest power is done by a digital power monitor located within each processor core.

5. The method of claim 1 wherein the P-state limit is programmable.

6. The method of claim 1 wherein the threshold limit is programmable.

7. The method of claim 1 further comprising:
lowering the voltage of a voltage regulator (VR) responsive to the sum exceeding the threshold limit.

8. The method of claim 1 further comprising:
signaling an interrupt indicating that a P-state limit has been enforced.

9. The method of claim 1 wherein the lower performance state includes at least one of: a lower power, a lower frequency or a lower voltage.

10. A maximum current limiting system configured for use in a multi-processor core system comprising:
a plurality of processor cores;
a plurality of power monitors, each power monitor associated with a corresponding processor core and configured to measure a latest power of the corresponding processor core;
an application power management (APM) controller configured to compare the sum of the latest power of the processor cores to a threshold limit; and
a plurality of processor core performance state (P-state) controllers configured to enforce a P-state limit on the plurality of processor cores responsive to the sum exceeding the threshold limit, wherein the plurality of processor cores enter a lower performance state.

11. The system of claim 10 wherein the plurality of power monitors are configured to measure the latest power for each processor core using fixed-time sampling.

12. The system of claim 11 wherein a sampling bandwidth of the fixed-time sampling exceeds the sampling bandwidth of a voltage regulator (VR).

13. The system of claim 10 wherein the plurality of power monitors are digital power monitors.

14. The system of claim 10 wherein the P-state limit is programmable.

15. The system of claim 10 wherein the threshold limit is programmable.

16. The system of claim 10 further comprising:
a voltage controller configured to lower the voltage of a voltage regulator (VR) responsive to the sum exceeding the threshold limit.

17. The system of claim 10 wherein:
the APM controller is further configured to signal an interrupt indicating that a P-state limit has been enforced.

18. The system of claim 10 wherein the lower performance state includes at least one of: a lower power, a lower frequency or a lower voltage.

19. A computer-readable storage medium storing a set of instructions for execution by one or more processors to facilitate manufacture of an execution unit of an integrated circuit that includes a maximum current limiting system configured for use with a multi-processor core system and that is adapted to:
measure a latest power for each processor core in a plurality of processor cores;
compare the sum of the latest power of the processor cores to a threshold limit; and
enforce a P-state limit on each processor core responsive to the sum exceeding the threshold limit, wherein the processor cores enter a lower performance state.

20. The computer-readable storage medium of claim 19, wherein the instructions are hardware description language (HDL) instructions used for manufacture of a device.
